(19) United States
(12) Patent Application Publication
(10) Pub. No.: US 2018/0215466 A1
(43) Pub. Date: Aug. 2, 2018

(54) AERIAL TREE HARVESTER

(71) Applicant: Geoffrey William Hall, Reno, NV (US)

(72) Inventor: Geoffrey William Hall, Reno, NV (US)

(21) Appl. No.: 15/748,215

(22) PCT Filed: Aug. 3, 2016
(86) PCT No.: PCT/US16/45235

§ 371 Date: Jan. 29, 2018

Related U.S. Application Data
(60) Provisional application No. 62/201,196, filed on Aug. 5, 2015.

(51) Int. Cl. B64D 1/22; A01G 23/091; A01G 23/081

(52) U.S. Cl. CPC B64D 1/22; A01G 23/081; A01G 23/091

(57) ABSTRACT

A machine operates in conjunction with an aircraft, such as a helicopter, for harvesting or removing trees. The device can be powered by the aircraft, by electrical or hydraulic connection with the aircraft, or it may have an independent, self-contained power source. The device includes jaws for grasping a tree, and a saw for cutting the tree. The weight of the device is borne by a strong and flexible cord suspended from the aircraft. Various motors enable the position of the device to be remotely controlled, so as to grasp and remove tree trunks. The invention is especially useful for removing trees from areas which are difficult to reach by land.

### CROSS-REFERENCE TO RELATED APPLICATIONS

Priority is claimed from U.S. provisional patent application Ser. No. 62/201,196, filed Aug. 5, 2015, the entire disclosure of which is hereby incorporated by reference.

### BACKGROUND OF THE INVENTION

The present invention provides a method and apparatus for harvesting trees, and is especially useful for harvesting trees from remote areas that are difficult to reach by land.

Whether for tree harvesting, tree thinning or removal of trees after a wildfire event, or removal of trees which have encroached on power lines, traditional tree harvesting or tree felling has long been conducted by persons and equipment based on the ground.

In earlier times, from the early twentieth century and going back to the early nineteenth century, little consideration was given to the state of the forest or to the eco-system within the forest. Logging was done on a massive scale to keep up with the demand caused by the industrial revolution and the subsequent expansion of human life at the time.

Nowadays there is more attention given to the environment by logging companies, and by government agencies having jurisdiction over forests, relating to forests on state and federal lands. Logging or tree harvesting, when managed correctly, can be an effective tool in the fight against the destructive effects of wildfires, and can comprise a sustainable industry which can provide a livelihood for many persons.

The present invention provides a new tool designed to enhance the safety of workers in the tree-harvesting industry, and to reduce negative effects on the environment.

Depending on the terrain, the logging or tree-harvesting process usually begins with experienced tree fellers cutting down a stand of trees. Retrieval of these trees can be done in a number of ways. An erected tower and winching system located near the site can be used, in cases where the steep terrain denies vehicle access. In other cases, in which the area of fallen trees is at least somewhat accessible, one can use vehicles such as bulldozers or dedicated tree handling equipment. Once the trees are winched or carried to a clearing known as a landing, they are processed into logs to enable transport via road to a sawmill or other processing plants, such as pulp processing plants etc.

The risk to ground-based personnel performing the above-described conventional removal of trees is high, particularly to the tree feller. The direction in which a tree may fall is unpredictable, and this fact makes the process of cutting down the tree dangerous. When felled, a tree may roll unpredictably in a direction toward the worker or workers on the ground.

Once the tree is on the ground, workers need to remove it from the forest and deliver it to a nearby processing site, usually within a mile or two of its original location. Here, the tree is de-limbed, debarked, measured, and cut into suitably sized logs for a lumber mill, to which it will be delivered on log trucks.

Various methods are used to transport the felled tree from its original location to the mill, depending on the terrain and accessibility. In steep terrain, ground-based vehicles such as bulldozers could be used to winch or tow a log to the processing site. An overhead cable, supported between two towers could also be used to drag the log. Finally, in less steep terrain, a tractor or modified excavator may be the vehicle of choice.

All of the above-described methods represent a high level of risk, either to the environment or the people performing the work. Damage can also be done to the delicate ecology of the forest, known as the understory or underbrush, where smaller plants bind the soil together and provide a habitat to insects, birds, lichens, and fungus, among other things.

Most importantly, many locations are extremely difficult to reach by land, even with the use of heavy equipment such as bulldozers, and removal of trees from such locations is expensive.

The present invention provides a method and device which solves the above-described problems. The present invention includes an apparatus, suspended from a helicopter, the apparatus being capable of grasping and cutting a tree, under remote control by an operator, and carrying the tree trunk away from the site. Thus, the tree can be harvested entirely from the air, avoiding the need for having any personnel on the ground.

### SUMMARY OF THE INVENTION

The aerial tree harvester (ATH) of the present invention is a machine that operates in conjunction with an aircraft, such as a helicopter, for the purpose of severing and removing a tree while the tree is still standing. The device can also grasp and remove a tree trunk which is lying on the ground. The device and method of the present invention eliminate the need for ground-based personnel or equipment.

The ATH of the present invention is attached to the aircraft by means of the aircraft's cargo hook, which is usually located on the underside or belly of the aircraft.

The ATH of the present invention has the following major components:

1) a sling or flexible cord which connects the aircraft to the ATH;

2) an anti-rotation mechanism, which prevents the ATH from rotating randomly around the axis of the sling;

3) a tree-grabbing mechanism, typically having the form of one or more pairs of jaws;

4) a saw or other cutting means to cut the tree after the tree has been grasped by the jaws;

5) a radio-controlled rotation mechanism which enables the pilot or other operator to rotate the device around a first axis, so as to orient the jaws in a desired direction; and

6) a separate radio-controlled rotation mechanism which enables the pilot or other operator to rotate the device around a second axis which is substantially perpendicular to the first axis.

The cord or sling is sufficiently strong to bear the weight of the device, and of a tree that has been lifted from the ground, while also having sufficient flexibility to absorb sudden large loads imposed on the system when the tree is cut, and when it is being lifted by the helicopter.

When the tree has been released from the ground, the jaws continue to hold the tree, which is still connected to the base of the aircraft by the sling or cord mechanism. The aircraft can then relocate the tree, and deposit it at a nearby site where the tree can be further processed.

The present invention therefore has a primary object of providing a method and apparatus for harvesting a tree, or a tree trunk, from an aircraft, in a remote location.

The invention has the further object of providing a method and apparatus for harvesting a tree, without the need for personnel on the ground.

The invention has the further object of providing a device for harvesting a tree from the air, the device being maneuverable in response to signals received from an operator, so that the device can grasp and cut the tree.

The invention has the further object of reducing the cost of harvesting trees and/or tree trunks from remote areas.

The reader skilled in the art will recognize other objects and advantages of the invention, from a reading of the following brief description of the drawings, the detailed description of the invention, and the appended claims.

### BRIEF DESCRIPTION OF THE DRAWINGS

FIG. 1 provides a perspective view of the aerial tree harvester of the present invention.

FIG. 2 provides a perspective view showing the articulated tube which extends between the aerial tree harvester and an aircraft.

FIG. 3 provides a fragmentary perspective view of the aerial tree harvester, showing the saw used for cutting trees.

FIG. 4 provides a fragmentary perspective view of one pair of jaws, forming part of the aerial tree harvester of the present invention, the jaws being used for grasping a tree trunk.

FIG. 5 provides a fragmentary perspective view of a rotation motor, forming part of the aerial tree harvester of the present invention, the motor being used for orienting the aerial tree harvester according to a radio signal initiated by the operator.

FIG. 6 provides another fragmentary perspective view of the aerial tree harvester of the present invention, showing the articulated tube which connects the harvester to an aircraft.

FIG. 7 provides a perspective view of the winch mechanism used for causing the aerial tree harvester to rotate around a pitch axis.

FIG. 8 provides a fragmentary perspective view of the harness stretch mechanism of the aerial tree harvester of the present invention.

FIG. 9 provides a simplified diagram showing the aerial tree harvester of the present invention, as it is being carried by a helicopter, the figure showing a rotated position of the aerial tree harvester in phantom.

FIG. 10 provides a diagram similar to FIG. 9, but also showing a tree which is engaged by the jaws of the aerial tree harvester of the present invention.

FIG. 11 provides a top view of dual radio control devices for controlling the movements of the aerial tree harvester of the present invention.

FIG. 12 provides a fragmentary perspective view of the bottom of a helicopter, showing the attachment of the device of the present invention to the helicopter.

FIG. 13 provides a fragmentary perspective view of the aerial tree harvester of the present invention, showing the camera and telemetry unit installed thereon.

FIG. 14 provides a fragmentary perspective view showing the attachment of the anti-rotation tube of the present invention, to the helicopter.

FIG. 15 provides a perspective view of the attachment of the anti-rotation tube to the helicopter, the view of FIG. 15 being taken in a direction that is orthogonal to that of FIG. 12.

### DETAILED DESCRIPTION OF THE INVENTION

The present invention includes an apparatus and method for harvesting a tree, through the use of an aircraft such as a helicopter. In this specification, the device of the invention is called an aerial tree harvester, or ATH. The ATH is a self-contained, radio-controlled tree harvesting machine which is suspended from the cargo hook of an aircraft such as a helicopter.

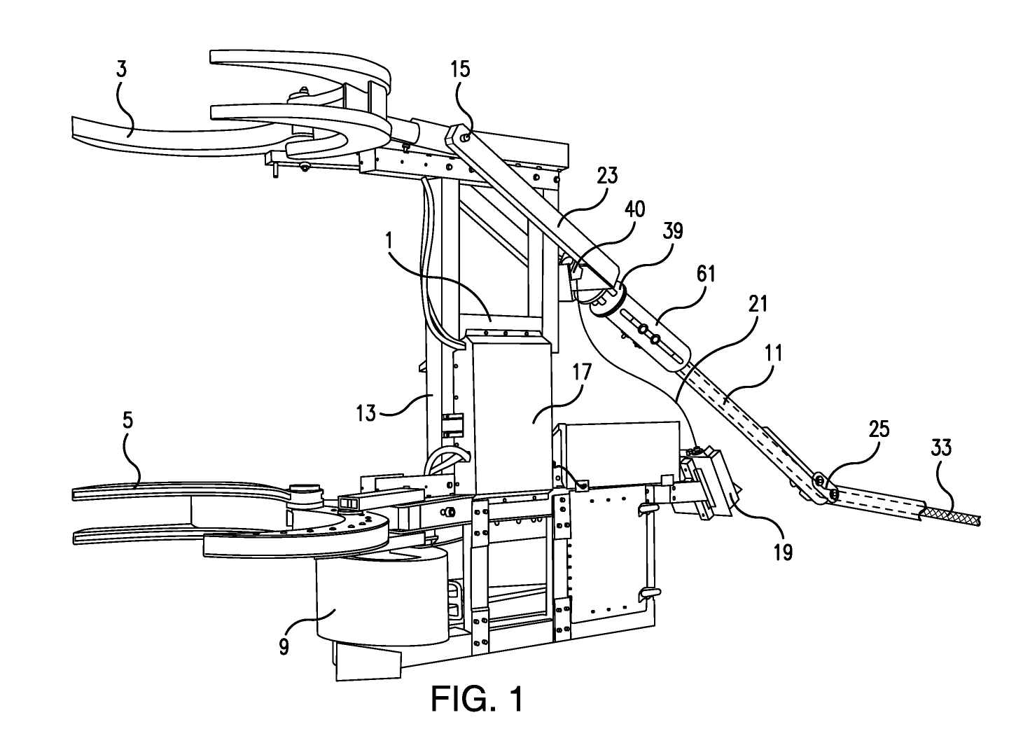

FIG. 1 provides a perspective view of the aerial tree harvester (ATH) of the present invention. The ATH includes frame 1 to which there is mounted at least one set of jaws 3. In the embodiment shown, there are two sets of jaws, identified by reference numerals 3 and 5. The jaws comprise remotely-controlled means for grasping a tree trunk.

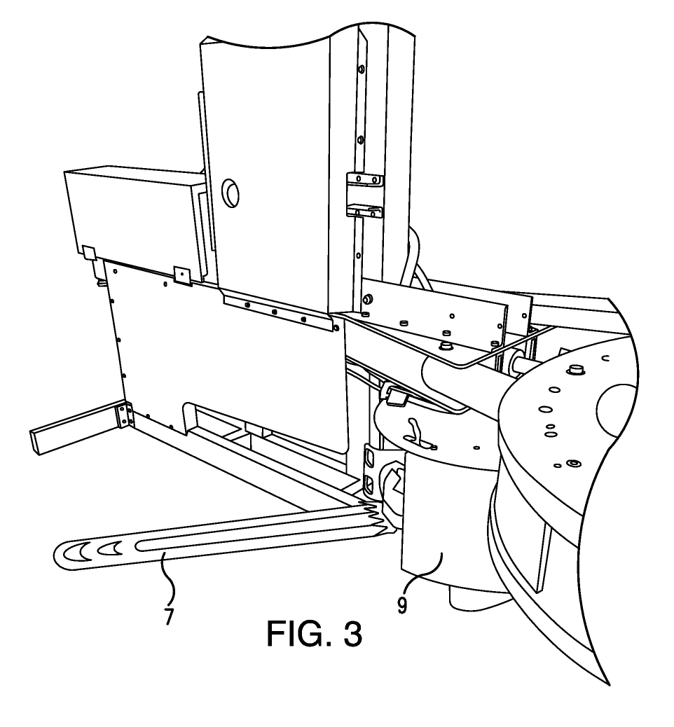

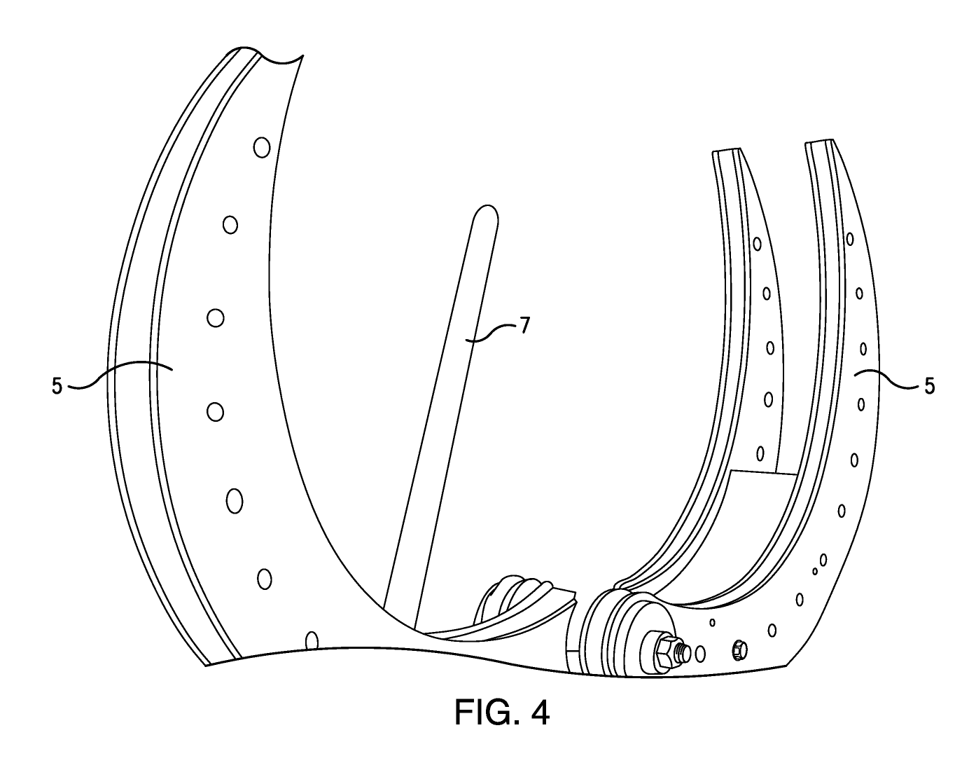

The ATH also includes means for cutting a tree trunk. In a preferred embodiment, the cutting means can be a saw, such as saw 7, visible in FIGS. 3 and 4. The saw can be a chain saw, or it can be some other form of saw. The saw is mounted to a rotatable turret 9, the rotation of which changes the position of the saw.

The ATH also includes cord means or sling 33, connected to the frame, the cord or sling being connectable to a helicopter. The cord means 33 is normally not visible because it is located within an articulated tube 11. In FIG. 1, the tube 11 is shown broken away, exposing a portion of the cord means, the portion of the cord means within tube 11 being shown in dotted outline.

The number of sets of jaws can be varied. In the preferred embodiment, there are two or more sets of jaws. The sets of jaws are preferably positioned about 8-10 feet apart from each other, but this spacing can be varied within the scope of the invention. The sets of jaws of FIG. 1 are configured so that they are oriented generally horizontally, but the orientation can be controllably varied, as will be described later. The jaws are attached to a vertical beam 13 of frame 1. The jaws protrude from the vertical beam, generally perpendicular thereto.

The frame includes a pivot pin 15, connected to the frame, allowing the tube 11 to pivot relative to the frame, and therefore allowing the entire ATH device to pivot when it is suspended from a helicopter.

The saw 7 is driven by a suitable motor, positioned within housing 17, which is mounted to the frame. The same motor, or a different motor, may be used to operate the jaws. A radio receiver, which receives signals from a transmitter located in the aircraft, may also be located within the same housing.

A winch 19 is mounted to the frame, and connected to cable 21. The cable 21 is connected to pivoting arm 23 at a position which is spaced apart from pivot pin 15. When the winch operates, so as to tighten cable 21, the result is that the ATH pivots around pivot pin 15. The winch therefore serves to change the orientation of the jaws from vertical to horizontal, or from horizontal to vertical. In the horizontal position, the jaws can easily grasp a standing tree trunk. In the vertical position, the jaws can grasp a tree trunk which lies on the ground.

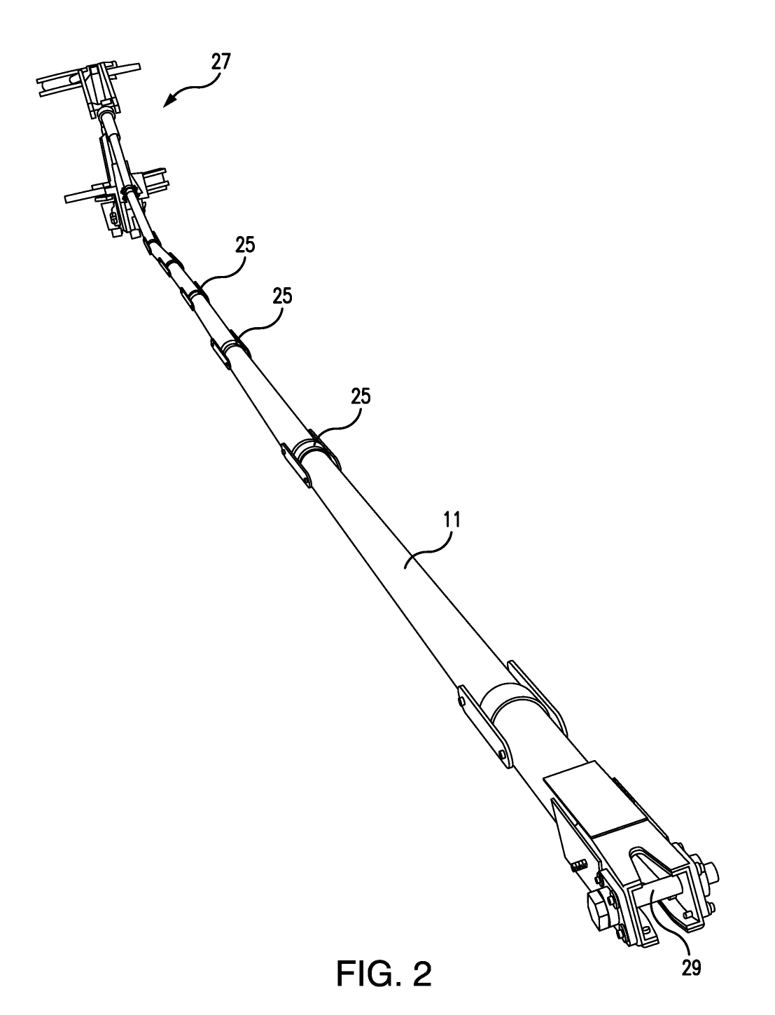

The tube 11 includes a plurality of pivot links 25, shown also in FIG. 2. FIG. 2 shows the tube 11 connected to the ATH 27 at one end, and to a pin 29 at the other, the pin 29 providing means for engaging a hook supported by an aircraft.

FIG. 3 provides more detail concerning the structure of the saw 7 and the turret 9. FIG. 4 provides more details concerning the jaws 5.

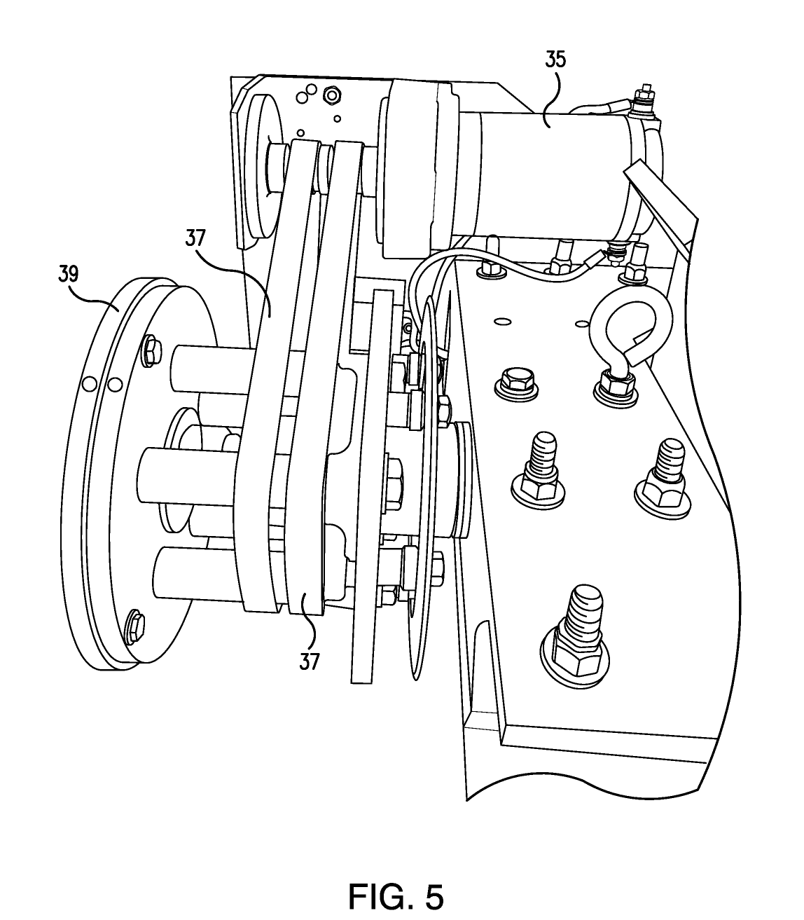

FIG. 5 illustrates the motor and drive assembly which enables the ATH to rotate. A motor 35 is connected by belts 37 to rotate a bearing 39, the bearing also being visible in FIG. 1. Rotation of bearing 39 causes the ATH to rotate relative to the tube 11. Stated another way, the articulated tube 11 has a longitudinal axis, and the motor 35 causes the ATH to rotate around the longitudinal axis of the tube 11, which is essentially the same as the longitudinal axis of the cord. The motor is located near the point at which the cable 21 attaches to the pivoting arm 23, indicated generally by reference numeral 40 in FIG. 1.

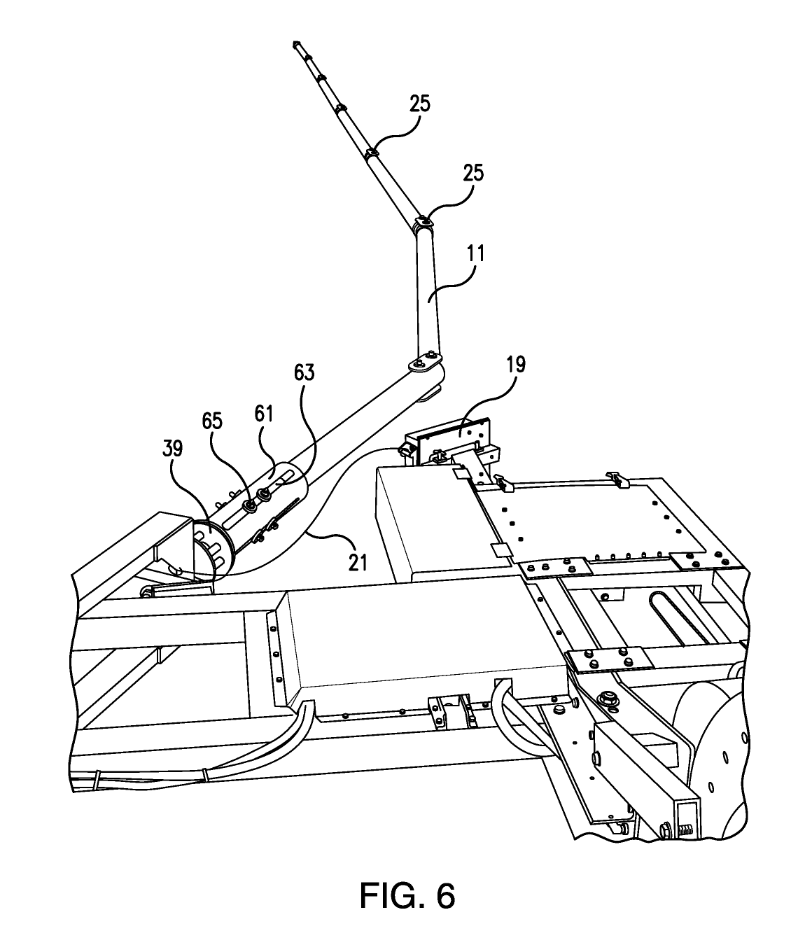

FIG. 6 provides a different view of the ATH and its connection to the articulated tube 11. The figure shows winch 19, connected to cable 21, as well as the bearing 39 which is turned by the motor of FIG. 5.

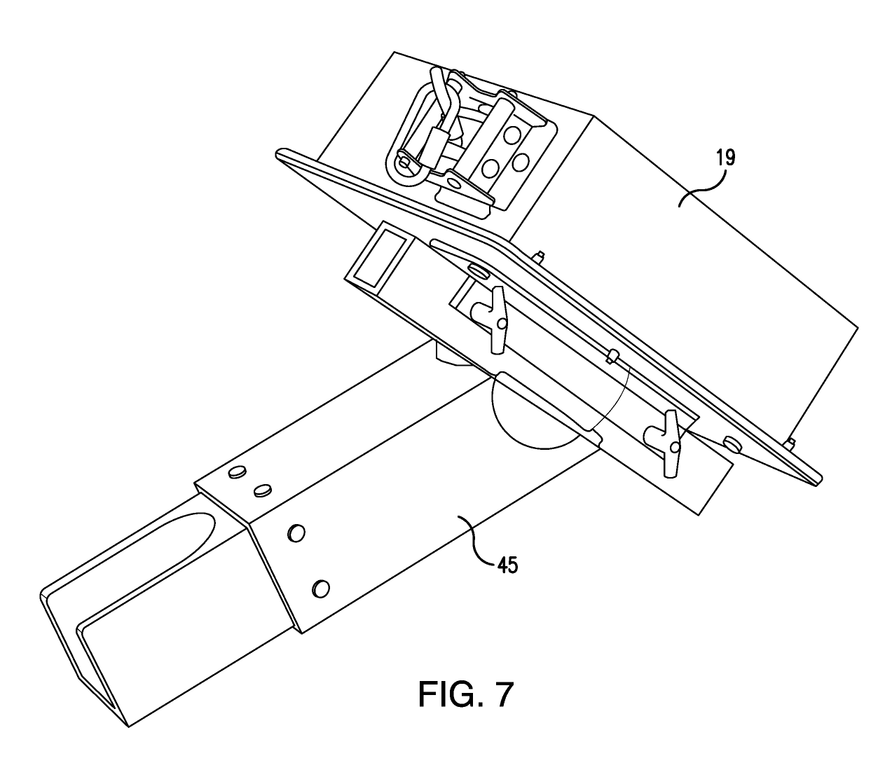

FIG. 7 provides a detailed drawing of winch 19 shown in FIG. 1, and also shows bracket 45 which attaches the winch to the frame 1.

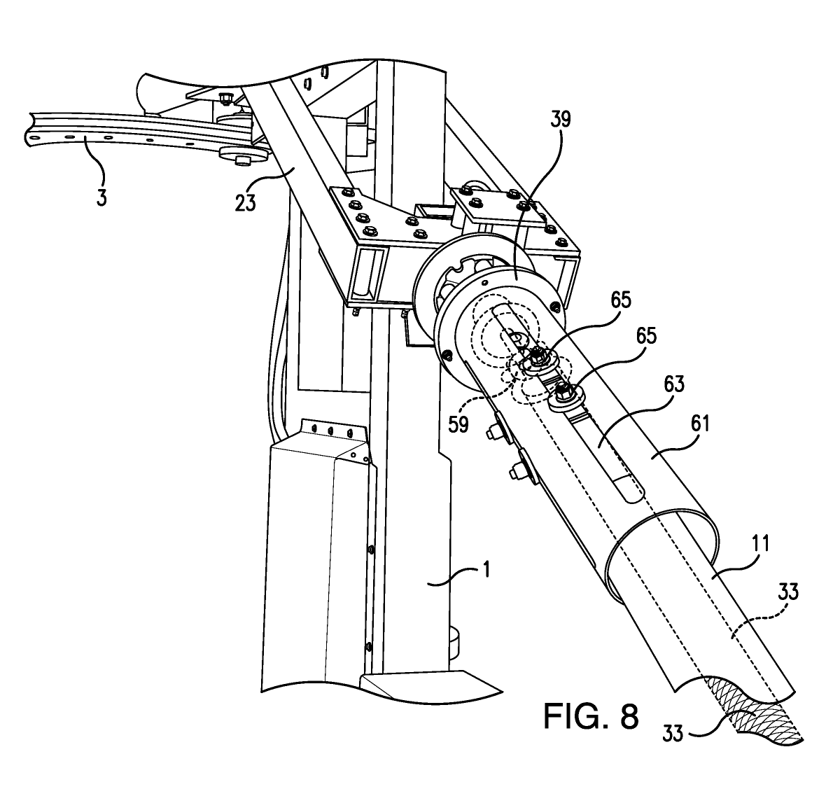

FIG. 8 provides more detail of the connection between the articulated tube 11, the pivoting arm 23, and the frame 1. In particular, the tube 11 is attached to bearing 39 through which the motor (shown in FIG. 5) causes the ATH to rotate relative to the tube 11.

As shown in FIG. 8, the articulated tube 11 is received in slotted tube 61. The articulated tube is anchored in slot 63 by bolts 65. The articulated tube 11 cannot rotate around its longitudinal axis, within the slotted tube 61, due to the anchoring of tube 11 in the slot, but the articulated tube 11 can slide along its longitudinal axis, along a distance determined by the length of the slot.

Note that the articulated tube 11 does not itself support the weight of the ATH. Instead, such weight is supported by cord means or sling 33, which could also be a bungee cord. The cord means extends through the entire tube 11, being connected, at one end, to the cargo hook near the aircraft, and being connected, at its other end, to an appropriate shackle which engages an eye bolt 59, located near, and connected to, the bearing 39. The cord is sufficiently strong to hold the weight of the ATH and a tree, and also sufficiently flexible to absorb the mechanical shock caused by the sudden severing of the tree, and the sudden suspension of the tree from the aircraft. The cord 33 and its connections are also identified, in this specification, as a harness stretch mechanism.

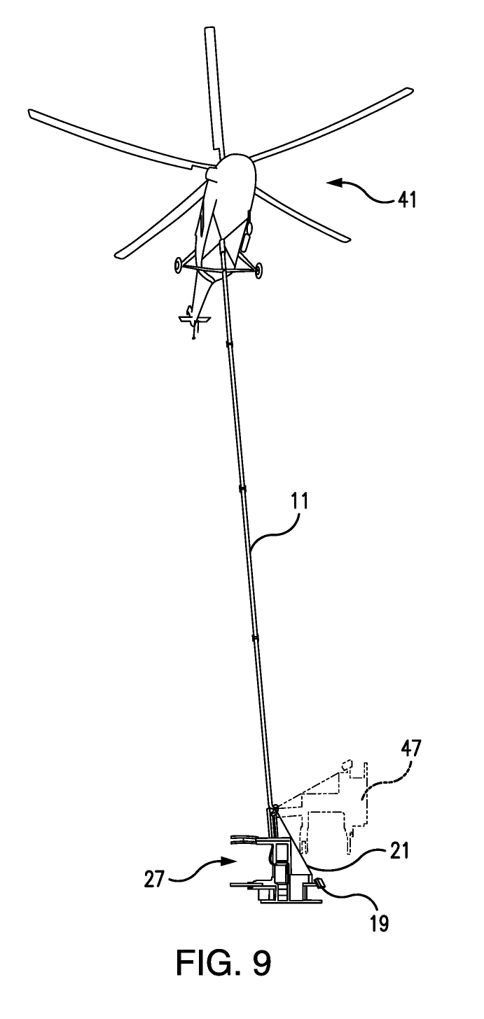

FIG. 9 provides a diagram illustrating the use of the present invention. FIG. 9 shows helicopter 41, supporting articulated tube 11, and showing the ATH 27 suspended by the harness stretch mechanism, i.e. the cord means disposed inside the tube. The cord is not visible in FIG. 9, as it is inside the articulated tube. The figure shows the ATH in the position such that the jaws can grasp a standing tree trunk. The figure also shows, in the dotted outline view indicated by reference numeral 47, the alternative position, induced by operation of the winch 19 on the cable 21 of FIG. 1, wherein the jaws are positioned to grasp a tree trunk which lies on the ground.

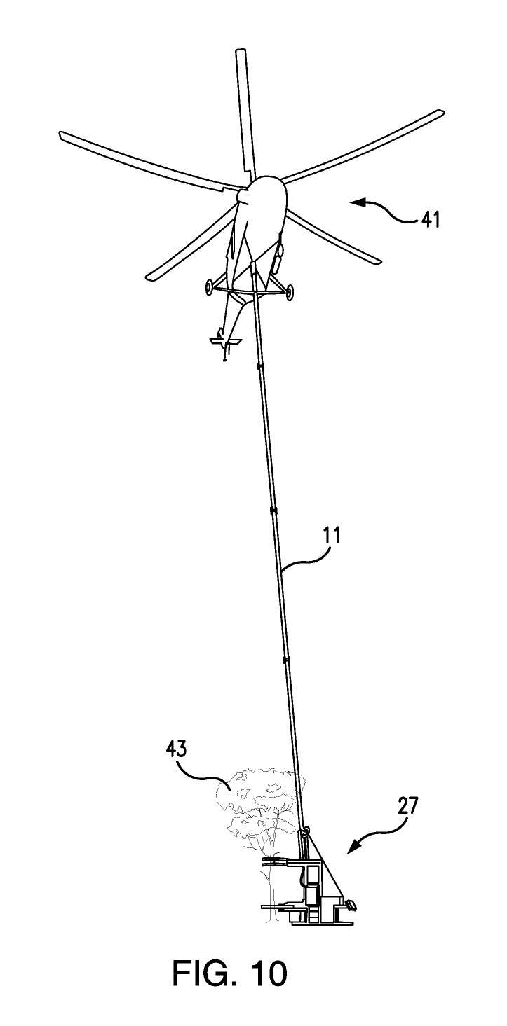

FIG. 10 is similar to FIG. 9, except that FIG. 10 also shows tree 43 being grasped by the jaws of the ATH.

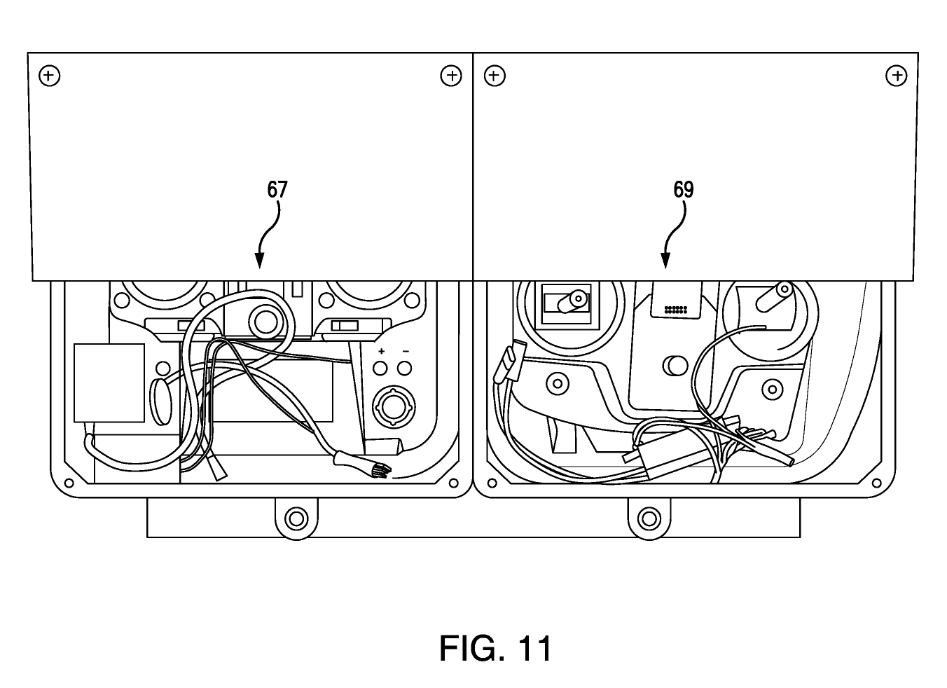

FIG. 11 provides a diagram of the duplicate transmitters 67, 69 located in the aircraft. The transmitters emit signals, controlled by a pilot or other operator in the helicopter, the signals comprising commands for the various components of the ATH.

It is important to include a secondary radio link, independent from the above-mentioned primary transmitter/receiver. The secondary radio system 69 has an independent power source, and an independent hydraulic/electrical circuit, and is operated by an independent control system. Its function is to act as an emergency release, should the ATH machine attach to the tree but then fail to release, as a result of a problem with the main radio link or control equipment. The secondary radio link system 69 is designed to release the clamp pressure on the tree without fully releasing. The aircraft pilot can completely decouple from the tree by applying force away from the tree with use of the aircraft's rotor thrust. This system also allows the pilot to relocate the jaws higher or lower along the tree trunk if necessary, by relaxing the grip of the jaws on the tree trunk.

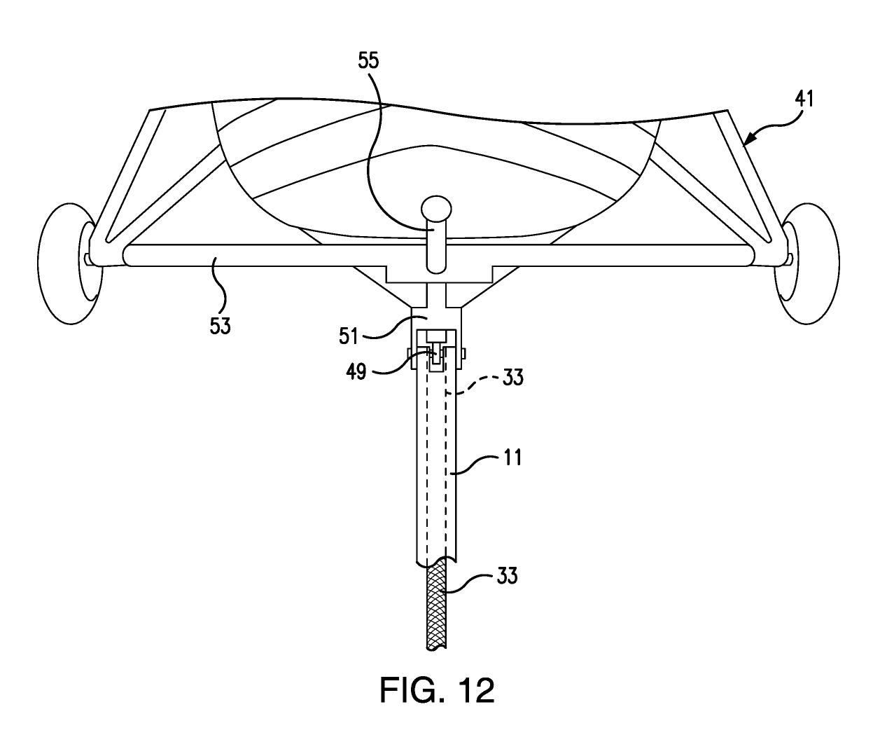

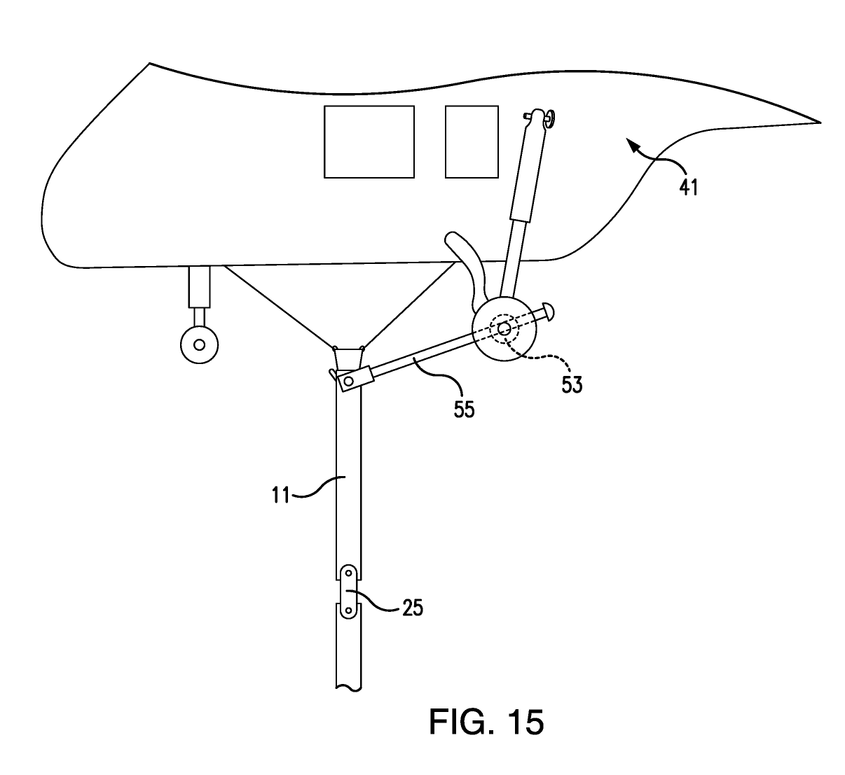

FIGS. 12, 14, and 15 illustrate the connections between the articulated tube 11 and the helicopter. FIGS. 12 and 15 show the helicopter 41 from mutually orthogonal views. FIG. 12 shows the articulated tube 11 connected to hook 49. The hook is connected to a bracket 51 which is connected to cross tube 53. The cross tube 53 is part of the device of the present invention, and is not part of the aircraft. The cross tube 53 fits in suitable recesses in the frame of the helicopter, and can be removed when the helicopter is being used without the ATH.

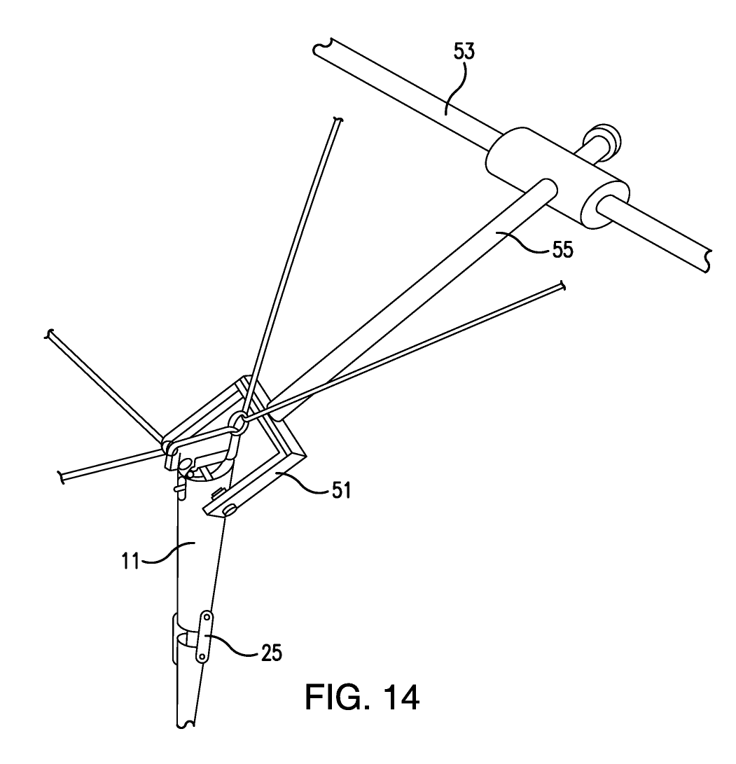

An anti-yaw tube 55 extends from the bracket 51 to the cross tube 53. The anti-yaw tube 55 is visible in FIGS. 12, but is more clearly shown in FIGS. 14 and 15. The anti-yaw tube tends to prevent unwanted, random rotation or twisting of the articulated tube 11 relative to the helicopter. By linking the tube 11 to the helicopter frame with a rigid structure such as the anti-yaw tube, the device thereby prevents unwanted, random rotation or twisting of the tube 11, and thus of the ATH as a whole.

In the view of FIG. 15, cross tube 53 is perpendicular to the paper, and is shown in dotted outline because it is hidden in this view.

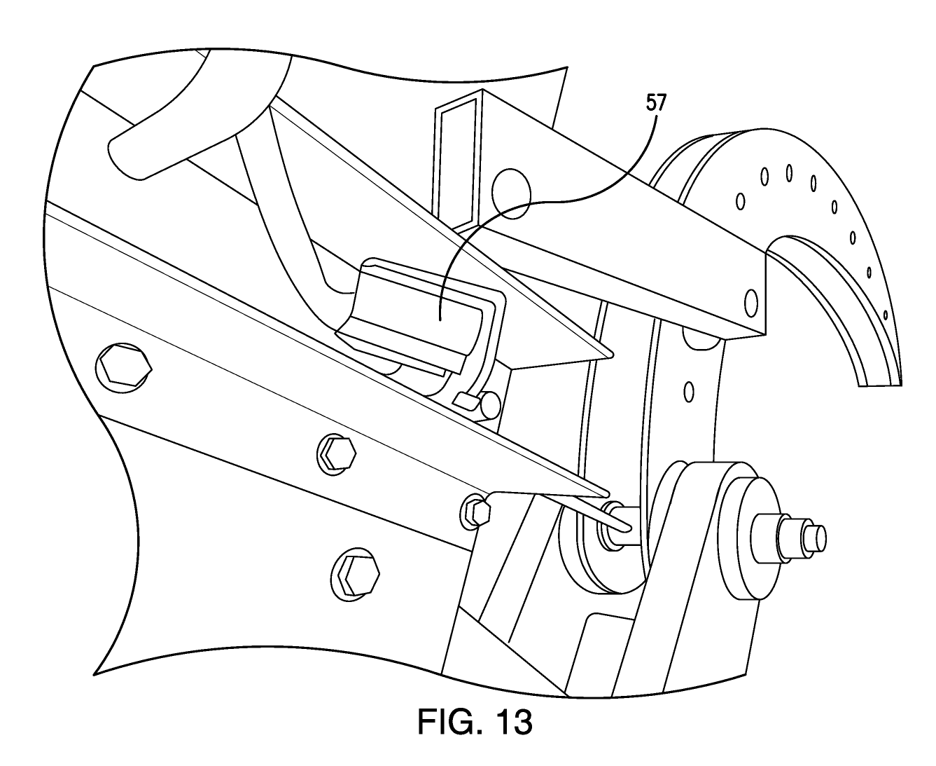

FIG. 13 shows a height telemetry and camera unit 57, mounted on the base of the ATH. The height telemetry device may comprise a radar altimeter, or other equivalent device. The telemetry and camera unit 57 sends, to the flight crew via a radio link, information regarding the height of the ATH above the ground level and a real time, close-up view of the saw and the jaws. This information allows the crew to know where to position the jaw mechanism to insure that the tree is removed at the desired position, if the tree is too heavy to take as a single load, as limited by the aircraft's lift performance. If a log of a specific length is required, to make it commercially viable to a purchaser, the length of the log can be estimated through use of the height telemetry system.

The present invention includes both a rotation apparatus and an anti-rotation apparatus. The rotation apparatus includes the motor shown in FIG. 5, which rotates the ATH with respect to the slotted tube 61, and therefore with respect to the articulated tube. This rotation allows the ATH to be rotated, when rotation is needed for positioning the device to grasp a tree. Also, the winch 19 and cable 21, which cause rotation of the ATH around the pivot pin 15, is another rotation apparatus. The anti-rotation apparatus includes the anti-yaw tube 55, shown most clearly in FIGS. 14 and 15, which prevents the ATH from rotating randomly relative to the helicopter.

The present invention includes five motor functions, which can be performed by up to five motors. These include the following:
1) a motor to drive the jaws;
2) a motor to drive the saw;
3) the motor 35 shown in FIG. 5, which causes rotation of the entire device around the longitudinal axes of the tube 11 and the cord;
4) the motor in winch 19, for tightening cable 21 and thereby causing the ATH to rotate around the pivot pin 15; and
5) a motor to rotate the turret 9.

Some of these motor functions can be combined in the same motor. For example, it is possible that motors (1) and (2) could be combined in the same unit.

Note also that the rotation of the ATH caused by the tightening of cable 21 by winch 19 comprises rotation around an axis which is orthogonal to the axis of rotation caused by motor 35 of FIG. 5. By combining varying amounts of rotations in these mutually orthogonal directions, and by also controlling the altitude of the helicopter, the pilot or operator can position the ATH in virtually any orientation.

In operation, the ATH is lowered by the helicopter to the side of a tree. The pilot, or other aircraft crew member, manipulates the jaws, using the wireless transmitter and receiver control, in a manner such that the ATH engages the tree trunk, as illustrated in FIG. 10. The machine is preferably designed with a combined clap pressure which can be in excess of 10,000 pounds, to insure that the trunk does not slip when the aircraft is carrying the tree. The jaws may be smooth, so as to insure that there is no damage to the tree trunk. But smooth jaws are not a limitation. The jaws could instead have teeth, if required to reduce the risk that the log might slip when the full weight of the tree is being carried.

Once the jaws are attached to the tree, the saw or other severing mechanism, mounted on the lower portion of the vertical beam 13 of the frame 1, below the lower set of jaws, is operated remotely so as to cut the tree, and to sever the tree completely from the earth.

When the tree has been cut, a shift of center of gravity usually occurs, causing the top of the tree to fall towards the ground, as the majority of the mass of the tree is usually at the end which is opposite to the position where the jaws are attached. This situation causes a rotating motion around the pivot pin 15 of FIG. 1.

The helicopter, still connected to the tree via the jaws and the sling harness, carries the tree to a nearby landing where it is released by the pilot or other crew member, using the wireless transmitter/receiver control. Thus, the tree is removed from the clutches of the Aerial Tree Harvester.

The aircraft pilot or other crew member(s) control the Aerial Tree Harvester, including the jaws and the saw, using the wireless transmitter/receiver controls located within the aircraft and within the ATH. A transmitter/receiver enables the aircraft crew to open and close the jaws, orient the jaws around the desired axis, and operate the saw. The orientation of the jaws can be determined by operation of winch 19, which, as explained above, causes the ATH to rotate about pivot pin 15, and by the rotation caused by motor 35 of FIG. 5.

The invention can be modified in various ways. The exact configuration of motors can be changed, and the number of the jaws can be increased. The motors can be electric or hydraulic, and the number and arrangement of the components of the telemetry unit, and of the control transmitters, can be modified. The nature and form of the jaws can be changed. These and other modifications, which will be apparent to those skilled in the art, should be considered within the spirit and scope of the following claims.

1-17. (canceled)

18. Apparatus for grasping and cutting a tree in a remote area, the apparatus comprising:
a) a frame,
b) remotely controlled means for grasping a tree trunk, the grasping means being mounted on the frame,
c) remotely controlled means for cutting a tree trunk, the cutting means being connected to the frame,
d) a flexible cord connected to the frame, the cord being disposed within an articulated tube, the articulated tube having a first end which is connected to the frame, and a second end which is connectable to an aircraft.

19. The apparatus of claim 18, wherein the articulated tube is connected to a pivoting arm which is mounted to the frame at a pivot point, wherein the apparatus includes a winch motor connected to a cable, the cable being attached to the pivoting arm at a position spaced apart from the pivot point, wherein tightening of the cable by the winch motor causes the apparatus to rotate about the pivot point.

20. The apparatus of claim 19, wherein the articulated tube is received in a slotted tube which is connected to the pivoting arm, wherein the articulated tube cannot rotate around its longitudinal axis, relative to the slotted tube, and wherein the articulated tube can slide along its longitudinal axis along a distance determined by a length of a slot.

21. The apparatus of claim 19, wherein the articulated tube has a longitudinal axis, and wherein the apparatus includes a second motor connected to rotate the apparatus around an axis which is substantially the same as the longitudinal axis of the articulated tube.

22. The apparatus of claim 18, further comprising an anti-yaw member, connected to the second end of the articulated tube, the anti-yaw member being connectable to an aircraft, the anti-yaw member being sufficiently rigid so as to prevent unintended twisting or rotation of the articulated tube.

23. The apparatus of claim 22, wherein the apparatus includes a bracket connected to the second end of the articulated tube, wherein the anti-yaw member comprises a tube connected to said bracket and also to a cross tube which is insertable into a frame of an aircraft.

24. The apparatus of claim 18, wherein the apparatus includes means for receiving control signals from an aircraft, and means for measuring altitude of the apparatus relative to ground, and camera means for viewing an environment of the apparatus and for transmitting data to an operator in the aircraft.

25. The apparatus of claim 18, wherein the grasping means comprises a pair of jaws, and wherein there are two pairs of jaws, the pairs of jaws being spaced apart from each other.

26. The apparatus of claim 18, wherein the cutting means comprises a saw, and wherein the saw extends from a rotatable turret mounted to the frame.

27. Apparatus for harvesting a tree in a remote location, comprising:
a) a frame supporting at least one jaw and at least one cutting means,
b) a flexible cord having a first end which is mounted to a pivoting arm, the pivoting arm being mounted to the frame at a pivot point and being pivotable relative to the frame, the flexible cord having a second end which is connectable to an aircraft,
c) first rotation means, the first rotation means comprising means for rotating the frame about the pivot point,
d) second rotation means, the second rotation means comprising means for rotating the frame about an axis which is substantially the same as a longitudinal axis of the cord, and
e) means for receiving signals from an operator in the aircraft, the receiving means being connected to operate the jaw, the cutting means, and the first and second rotation means.

28. The apparatus of claim 27, wherein the flexible cord is disposed within an articulated tube, the articulated tube having a first end which is attached to a pivoting arm connected to the frame, and a second end which is connectable to an aircraft, wherein the second rotation means comprises means for rotating the frame about a longitudinal axis of the articulated tube.

29. The apparatus of claim 28, wherein the articulated tube is received in a slotted tube which is connected to the pivoting arm, wherein the articulated tube cannot rotate around its longitudinal axis, relative to the slotted tube, and wherein the articulated tube can slide along its longitudinal axis along a distance determined by a length of a slot.

30. The apparatus of claim 28, further comprising an anti-yaw tube, connected to the second end of the articulated tube, and being connectable to an aircraft.

31. The apparatus of claim 30, wherein the apparatus includes a bracket connected to the second end of the articulated tube, and wherein the anti-yaw tube is connected to said bracket and also to a cross tube which is insertable into a frame of an aircraft.

32. A method of aerial harvesting of a felled tree trunk, the method comprising the steps of:
a) suspending a grasping and cutting device, by a flexible cord, from a helicopter, in a vicinity of a tree trunk to be harvested,
b) remotely operating at least one jaw, mounted on the grasping and cutting device, so as to engage the tree trunk, the remotely operating step including the steps of controlling a first and second rotation means, wherein the first rotation means comprises means for rotating the frame about a pivot point, and wherein the second rotation means comprises means for rotating the frame about an axis which is substantially the same as a longitudinal axis of the flexible cord, wherein the grasping and cutting device is remotely positioned to grasp and cut a tree, and wherein the tree trunk is suspended from the helicopter, and
c) carrying the tree trunk, by helicopter, to another location.

33. The method of claim 32, wherein the grasping and cutting device includes an altimeter and a camera, and means for transmitting information from the altimeter and camera to an operator in the helicopter, and wherein the method includes using said information to position the grasping and cutting device so as to harvest a tree trunk.
